(19) United States
(12) Patent Application Publication
(10) Pub. No.: US 2025/0039627 A1
(43) Pub. Date: Jan. 30, 2025

(54) A Method and Apparatus for AR Scene Modification

(71) Applicant: Nokia Technologies Oy, Espoo (FI)

(72) Inventors: Jussi Artturi LEPPANEN, Tampere (FI); Arto Juhani LEHTINIEMI, Lempaala (FI)

(21) Appl. No.: 18/715,202

(22) PCT Filed: Nov. 22, 2022
(86) PCT No.: PCT/FI2022/050774

§ 371 Date: May 31, 2024

(30) Foreign Application Priority Data
Dec. 14, 2021 (GB) 2118094.8

(51) Int. Cl. H04S 7/00

(52) U.S. Cl. CPC H04S 7/304; H04R 2499/15

(57) ABSTRACT

An apparatus for generating information to assist rendering an audio scene, the apparatus including circuitry configured to: obtain an audio signal; obtain a scene parameter associated with the audio signal, the scene parameter being configured to define a position within the audio scene; obtain an anchor parameter associated with the audio signal, wherein the anchor parameter is associated with a listening space anchor located within a listening space during rendering and the anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream including the audio signal, the scene parameter, and an anchor parameter.

### FIELD

The present application relates to method and apparatus for augmented reality scene modification, and for method and apparatus for augmented reality scene modification using scaling tags and anchors.

### BACKGROUND

Augmented Reality (AR) applications (and other similar virtual scene creation applications such as Mixed Reality (MR) and Virtual Reality (VR)) where a virtual scene is represented to a user wearing a head mounted device (HMD) have become more complex and sophisticated over time. The application may comprise data which comprises a visual component (or overlay) and an audio component (or overlay) which is presented to the user. These components may be provided to the user dependent on the position and orientation of the user (for a 6 degree-of-freedom application) within an Augmented Reality (AR) scene.

Scene information for rendering an AR scene typically comprises two parts. One part is the virtual scene information which may be described during content creation (or by a suitable capture apparatus or device) and represents the scene as captured (or initially generated). The virtual scene may be provided in an encoder input format (EIF) data format. The EIF and (captured or generated) audio data is used by an encoder to generate the scene description and spatial audio metadata (and audio signals), which can be delivered via the bitstream to the rendering (playback) device or apparatus. The scene description for an AR or VR scene is thus specified by the content creator during a content creation phase. In the case of VR, the scene is specified in its entirety and it is rendered exactly as specified in the content creator bitstream.

The second part of the AR audio scene rendering is related to the physical listening space (or physical space) of the listener (or end user). The scene or listener space information may be obtained during the AR rendering (when the listener is consuming the content). Thus there is a fundamental aspect of AR which is different from VR, which means the acoustic properties of the audio scene are known (for AR) only during content consumption and cannot be known or optimized during content creation.

The scene description for an AR or VR scene is specified by the content creator during content creation phase. In case of VR, the scene is specified in its entirety and it is rendered exactly as specified in the content creator bitstream. There is a fundamental aspect of AR which is different from VR, which means the acoustic properties of the audio scene are known in case of AR only during content consumption and cannot be known or optimized during content creation. The implications of this difference are elaborated further in the following.

The content creator will not generally know the size of the listening space that the content will be consumed in. Furthermore, different users or listeners will inevitably have different sized listening spaces. The size of the listening space is only known at the time of rendering. Positions and parameters of audio elements (walls and their reflection coefficients based on device sensor information, for example) in the listening space are obtained during rendering and combined with the scene information to obtain the scene that is rendered to the user.

### SUMMARY

There is provided according to a first aspect an apparatus for generating information to assist rendering an audio scene, the apparatus comprising means configured to: obtain at least one audio signal; obtain at least one scene parameter associated with the at least one audio signal, the at least one scene parameter being configured to define a position within the audio scene, wherein the audio scene is defined by the at least one audio signal and the at least one scene parameter; obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream comprising the at least one audio signal, the at least one scene parameter and at least one anchor parameter.

The means may be further configured to obtain a scene origin parameter wherein the position within the audio scene is defined relative to the scene origin parameter, and wherein the bitstream further comprises the scene origin parameter.

The at least one anchor parameter may define a geometric shape at least partially defining a boundary of the audio scene wherein the position is within the boundary of the audio scene, and the mapped position maps the boundary of the audio scene within the listening space.

According to a second aspect there is provided an apparatus for rendering an audio scene within a listening space, the apparatus comprising means configured to: obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtain at least one listening space anchor, the at least one listening space anchor configured to at least partially define a listening space geometry; obtain a listener position relative to the listening space; map the position within the audio scene to a listening space position within the listening space wherein the means configured to map the position within the audio scene to the listening space position is configured to map the position within the listening space based on the position within the audio scene, the at least one anchor parameter and the at least one listening space anchor such that the audio scene is scaled to fit within the listening space and/or the mapped position at least in part modifies the listening space; and render at least one spatial audio signal based on the listener position within the listening space, the at least one audio signal and the listening space position within the listening space.

The at least one anchor parameter may at least partially defines a geometric shape defining a boundary of the audio scene.

The bitstream may further comprises a scene origin, and wherein the means configured to render at least one spatial audio signal based on the listener position within the listening space, the at least one audio signal and the listening space position within the listening space may be configured to render the at least one spatial audio signal further based on the listening position within the listening space and the scene origin with respect to the geometric shape defining the boundary of the audio scene.

The means configured to obtain at least one listening space parameter, the at least one listening space parameter configured to define a listening space geometry may comprise means configured to: measure the listening space geometry; receive the listening space geometry from at least one user input; and determine the listening space geometry from signals received from tracking beacons within the listening space.

The means configured to map the position within the audio scene to the listening space position may be configured to: generate scaling multipliers based on the on the at least one anchor parameter and the associated at least one listening space anchor; and apply the scaling multipliers to the position within the audio scene to determine the position within the listening space.

The means configured to map the position within the audio scene to the listening space position may be configured to modify at least one of: the listening space such that the listening space is cropped; the listening space such that the listening space is cut; the listening space such that the listening space is limited; and the listening space such that a listening space area is limited and interaction with any sound sources outside the listening space area is not possible.

According to a third aspect there is provided a method for an apparatus for generating information to assist rendering an audio scene, the method comprising: obtaining at least one audio signal; obtaining at least one scene parameter associated with the at least one audio signal, the at least one scene parameter being configured to define a position within the audio scene, wherein the audio scene is defined by the at least one audio signal and the at least one scene parameter; obtaining at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generating a bitstream comprising the at least one audio signal, the at least one scene parameter and at least one anchor parameter.

The method may further comprise obtaining a scene origin parameter wherein the position within the audio scene is defined relative to the scene origin parameter, and wherein the bitstream may further comprise the scene origin parameter.

The at least one anchor parameter may define a geometric shape at least partially defining a boundary of the audio scene wherein the position is within the boundary of the audio scene, and the mapped position may map the boundary of the audio scene within the listening space.

According to a fourth aspect there is provided a method for an apparatus for rendering an audio scene within a listening space, the method comprising: obtaining a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtaining at least one listening space anchor, the at least one listening space anchor configured to at least partially define a listening space geometry; obtaining a listener position relative to the listening space; mapping the position within the audio scene to a listening space position within the listening space wherein mapping the position within the audio scene to the listening space position comprises mapping the position within the listening space based on the position within the audio scene, the at least one anchor parameter and the at least one listening space anchor such that the audio scene is scaled to fit within the listening space and/or the mapped position at least in part modifies the listening space; and rendering at least one spatial audio signal based on the listener position within the listening space, the at least one audio signal and the listening space position within the listening space.

The at least one anchor parameter may at least partially defines a geometric shape defining a boundary of the audio scene.

The bitstream may further comprise a scene origin, and wherein rendering at least one spatial audio signal based on the listener position within the listening space, the at least one audio signal and the listening space position within the listening space may comprise rendering the at least one spatial audio signal further based on the listening position within the listening space and the scene origin with respect to the geometric shape defining the boundary of the audio scene.

Obtaining at least one listening space parameter, the at least one listening space parameter configured to define a listening space geometry may comprise: measuring the listening space geometry; receiving the listening space geometry from at least one user input; and determining the listening space geometry from signals received from tracking beacons within the listening space.

Mapping the position within the audio scene to the listening space position may comprise: generating scaling multipliers based on the on the at least one anchor parameter and the associated at least one listening space anchor; and applying the scaling multipliers to the position within the audio scene to determine the position within the listening space.

Mapping the position within the audio scene to the listening space position may comprise modifying at least one of: the listening space such that the listening space is cropped; the listening space such that the listening space is cut; the listening space such that the listening space is limited; and the listening space such that a listening space area is limited and interaction with any sound sources outside the listening space area is not possible.

According to a fifth aspect there is provided an apparatus for generating information to assist rendering an audio scene, the apparatus comprising at least one processor and at least one memory including a computer program code, the at least one memory and the computer program code configured to, with the at least one processor, cause the apparatus at least to: obtain at least one audio signal; obtain at least one scene parameter associated with the at least one audio signal, the at least one scene parameter being configured to define a position within the audio scene, wherein the audio scene is defined by the at least one audio signal and the at least one scene parameter; obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream comprising the at least one audio signal, the at least one scene parameter and at least one anchor parameter.

The apparatus may be further caused to obtain a scene origin parameter wherein the position within the audio scene is defined relative to the scene origin parameter, and wherein the bitstream further comprises the scene origin parameter.

The at least one anchor parameter may define a geometric shape at least partially defining a boundary of the audio scene wherein the position is within the boundary of the audio scene, and the mapped position maps the boundary of the audio scene within the listening space.

According to a sixth aspect there is provided an apparatus for rendering an audio scene within a listening space, the apparatus comprising at least one processor and at least one memory including a computer program code, the at least one memory and the computer program code configured to, with the at least one processor, cause the apparatus at least to: obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtain at least one listening space anchor, the at least one listening space anchor configured to at least partially define a listening space geometry; obtain a listener position relative to the listening space; map the position within the audio scene to a listening space position within the listening space wherein the means configured to map the position within the audio scene to the listening space position is configured to map the position within the listening space based on the position within the audio scene, the at least one anchor parameter and the at least one listening space anchor such that the audio scene is scaled to fit within the listening space and/or the mapped position at least in part modifies the listening space; and render at least one spatial audio signal based on the listener position within the listening space, the at least one audio signal and the listening space position within the listening space.

The at least one anchor parameter may at least partially defines a geometric shape defining a boundary of the audio scene.

The bitstream may further comprises a scene origin, and wherein the apparatus caused to render at least one spatial audio signal based on the listener position within the listening space, the at least one audio signal and the listening space position within the listening space may be caused to render the at least one spatial audio signal further based on the listening position within the listening space and the scene origin with respect to the geometric shape defining the boundary of the audio scene.

The apparatus caused to obtain at least one listening space parameter, the at) least one listening space parameter configured to define a listening space geometry may be caused to: measure the listening space geometry; receive the listening space geometry from at least one user input; and determine the listening space geometry from signals received from tracking beacons within the listening space.

The apparatus caused to map the position within the audio scene to the listening space position may be caused to: generate scaling multipliers based on the on the at least one anchor parameter and the associated at least one listening space anchor; and apply the scaling multipliers to the position within the audio scene to determine the position within the listening space.

The apparatus caused to map the position within the audio scene to the listening space position may be caused to modify at least one of: the listening space such that the listening space is cropped; the listening space such that the listening space is cut; the listening space such that the listening space is limited; and the listening space such that a listening space area is limited and interaction with any sound sources outside the listening space area is not possible.

According to a seventh aspect there is provided an apparatus comprising: means for obtaining at least one audio signal; means for obtaining at least one scene parameter associated with the at least one audio signal, the at least one scene parameter being configured to define a position within the audio scene, wherein the audio scene is defined by the at least one audio signal and the at least one scene parameter; means for obtaining at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and means for generating a bitstream comprising the at least one audio signal, the at least one scene parameter and at least one anchor parameter.

According to an eighth aspect there is provided an apparatus comprising: means for obtaining a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; means for obtaining at least one listening space anchor, the at least one listening space anchor configured to at least partially define a listening space geometry; means for obtaining a listener position relative to the listening space; means for mapping the position within the audio scene to a listening space position within the listening space wherein the means for mapping the position within the audio scene to the listening space position comprised means for mapping the position within the listening space based on the position within the audio scene, the at least one anchor parameter and the at least one listening space anchor such that the audio scene is scaled to fit within the listening space and/or the mapped position at least in part modifies the listening space; and means for rendering at least one spatial audio signal based on the listener position within the listening space, the at least one audio signal and the listening space position within the listening space.

According to a ninth aspect there is provided a computer program comprising instructions or a computer readable medium comprising program instructions] for causing an apparatus to perform at least the following: obtain at least one audio signal; obtain at least one scene parameter associated with the at least one audio signal, the at least one scene parameter being configured to define a position within the audio scene, wherein the audio scene is defined by the at least one audio signal and the at least one scene parameter; obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream comprising the at least one audio signal, the at least one scene parameter and at least one anchor parameter.

According to a tenth aspect there is provided a computer program comprising instructions or a computer readable medium comprising program instructions] for causing an apparatus to perform at least the following: obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtain at least one listening space anchor, the at least one listening space anchor configured to at least partially define a listening space geometry; obtain a listener position relative to the listening space; map the position within the audio scene to a listening space position within the listening space wherein the means configured to map the position within the audio scene to the listening space position is configured to map the position within the listening space based on the position within the audio scene, the at least one anchor parameter and the at least one listening space anchor such that the audio scene is scaled to fit within the listening space and/or the mapped position at least in part modifies the listening space; and render at least one spatial audio signal based on the listener position within the listening space, the at least one audio signal and the listening space position within the listening space.

According to a eleventh aspect there is provided a non-transitory computer readable medium comprising program instructions for causing an apparatus to perform at least the following: obtain at least one audio signal; obtain at least one scene parameter associated with the at least one audio signal, the at least one scene parameter being configured to define a position within the audio scene, wherein the audio scene is defined by the at least one audio signal and the at least one scene parameter; obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream comprising the at least one audio signal, the at least one scene parameter and at least one anchor parameter.

According to a twelfth aspect there is provided a non-transitory computer readable medium comprising program instructions for causing an apparatus to perform at least the following: obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtain at least one listening space anchor, the at least one listening space anchor configured to at least partially define a listening space geometry; obtain a listener position relative to the listening space; map the position within the audio scene to a listening space position within the listening space wherein the means configured to map the position within the audio scene to the listening space position is configured to map the position within the listening space based on the position within the audio scene, the at least one anchor parameter and the at least one listening space anchor such that the audio scene is scaled to fit within the listening space and/or the mapped position at least in part modifies the listening space; and render at least one spatial audio signal based on the listener position within the listening space, the at least one audio signal and the listening space position within the listening space.

According to a thirteenth aspect there is provided an apparatus comprising: obtaining circuitry configured to obtain at least one audio signal; obtaining circuitry configured to obtain at least one scene parameter associated with the at least one audio signal, the at least one scene parameter being configured to define a position within the audio scene, wherein the audio scene is defined by the at least one audio signal and the at least one scene parameter; obtaining circuitry configured to obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generating circuitry configured to generate a bitstream comprising the at least one audio signal, the at least one scene parameter and at least one anchor parameter.

According to a fourteenth aspect there is provided an apparatus comprising: obtaining circuitry configured to obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtaining circuitry configured to obtain at least one listening space anchor, the at least one listening space anchor configured to at least partially define a listening space geometry; obtaining circuitry configured to obtain a listener position relative to the listening space; mapping circuitry configured to map the position within the audio scene to a listening space position within the listening space wherein the mapping the position within the audio scene to the listening space position may be configured to map the position within the listening space based on the position within the audio scene, the at least one anchor parameter and the at least one listening space anchor such that the audio scene is scaled to fit within the listening space and/or the mapped position at least in part modifies the listening space; and rendering circuitry configured to render at least one spatial audio signal based on the listener position within the listening space, the at least one audio signal and the listening space position within the listening space.

According to a fifteenth aspect there is provided a computer readable medium comprising program instructions for causing an apparatus to perform at least the following: obtain at least one audio signal; obtain at least one scene parameter associated with the at least one audio signal, the at least one scene parameter being configured to define a position within the audio scene, wherein the audio scene is defined by the at least one audio signal and the at least one scene parameter; obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being a virtual and/or physical space within which the audio scene is rendered, wherein the mapped position is scaled to fit within the listening space and/or the mapped position at least in part modifies the listening space; and generate a bitstream comprising the at least one audio signal, the at least one scene parameter and at least one anchor parameter.

According to a sixteenth aspect there is provided a computer readable medium comprising program instructions for causing an apparatus to perform at least the following: obtain a bitstream, the bitstream comprising: at least one audio signal; at least one scene parameter associated with the at least one audio signal, the at least one scene parameter being configured to define a position within the audio scene, wherein the audio scene is defined by the at least one audio signal and the at least one scene parameter; at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene; obtain at least one listening space anchor, the at least one listening space anchor configured to at least partially define a listening space geometry; obtain a listener position relative to the listening space; map the position within the audio scene to a listening space position within the listening space wherein the means configured to map the position within the audio scene to the listening space position is configured to map the position within the listening space based on the position within the audio scene, the at least one anchor parameter and the at least one listening space anchor such that the audio scene is scaled to fit within the listening space and/or the mapped position at least in part modifies the listening space; and render at least one spatial audio signal based on the listener position within the listening space, the at least one audio signal and the listening space position within the listening space.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIGS. 1a to 1c show schematically a combination of virtual scene elements within a physical listening space;

FIG. 2 show schematically an example system of apparatus;

FIGS. 3a to 3c show schematically a combination of virtual scene elements within a physical listening space wherein the virtual scene elements are larger than the listening space;

FIGS. 4a to 4c show schematically a combination of virtual scene elements within a physical listening space which is scaled according to some embodiments;

FIG. 5 show schematically an example system of apparatus according to some embodiments;

FIG. 6 shows a flow diagram of the operation of the system of apparatus as shown in FIG. 5 according to some embodiments;

FIGS. 7a to 7h shows schematically an example operation of the renderer as shown in FIG. 5 according to some embodiments;

FIG. 8 shows schematically an example implementation of the system of apparatus as shown in FIG. 5;

FIG. 9 shows schematically a further example implementation according to some embodiments; and

FIG. 10 shows schematically an example device suitable for implementing the apparatus shown.

### EMBODIMENTS OF THE APPLICATION

The following describes in further detail suitable apparatus and possible mechanisms for rendering a virtual (VR) or augmented (AR) scene experience. In the following examples the apparatus and scenarios described are those of an augmented scene experience, but can expanded to (pure) virtual scene experience or mixed (xR) scene experience examples without significant inventive input.

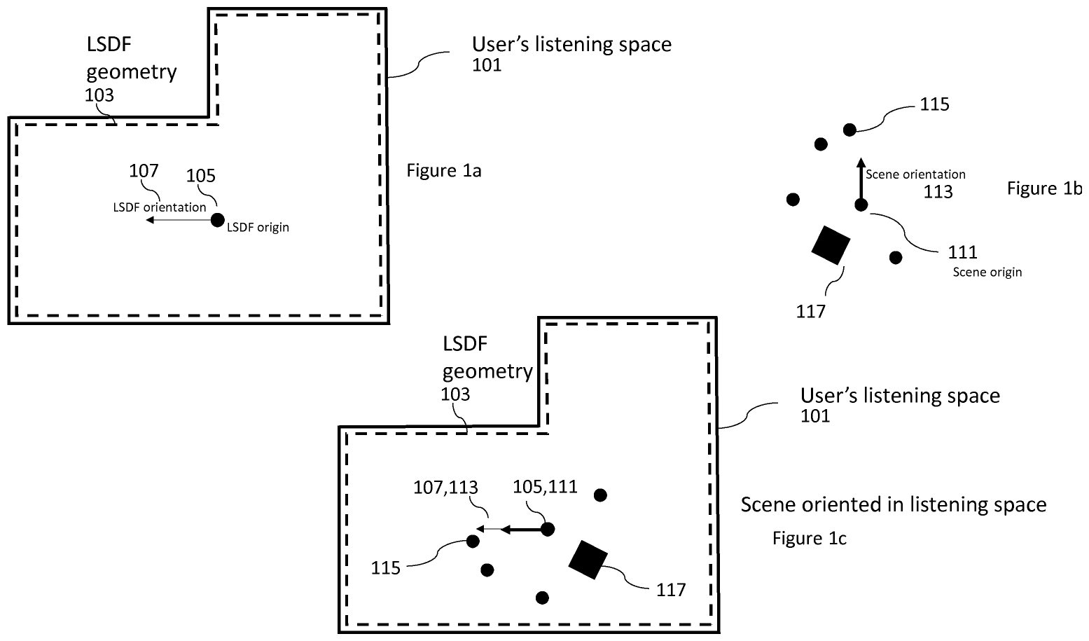

FIGS. 1a to 1c show an example of placing a content creator defined audio scene into the listening space during rendering.

FIG. 1a shows an example where the user's (or listener's) space 101 is represented by a LSDF geometry 103 (or suitable listening space descriptor format) which models the listening space within which the listener is located. The geometry 103 may model the physical aspects, such as wall and other item dimensions, and also the acoustic aspects of the listening space, such as the acoustic transparency or reflectivity. Additionally the LSDF geometry can define a LSDF origin 105 and orientation 107 which models a position and orientation within the listening space.

FIG. 1b shows example virtual scene information which may be described during content creation (or by a suitable capture apparatus or device) and represents the scene as captured (or initially generated). The virtual scene may be provided in an encoder input format (EIF) data format or any suitable format. The scene description describes a scene origin 111 and scene orientation 113, scene sources 115, represented by the circles, and scene objects 117 represented by the block 117. The scene sources 115 can represent point (or otherwise distributed) audio sources and have associated audio signals (and metadata). The scene objects 117 can represent windows, furniture, walls and comprise parameters which define the object such as their position, size and reflective, refractive, transparency acoustic parameters.

FIG. 1c shows an example combination of the scene orientated within the user's (or listener's) space 101 where the scene origin 111 and LSDF origin 105 are aligned and the scene orientation 113 aligned with the LSDF orientation 107. In this example once aligned the scene fits within the user's space.

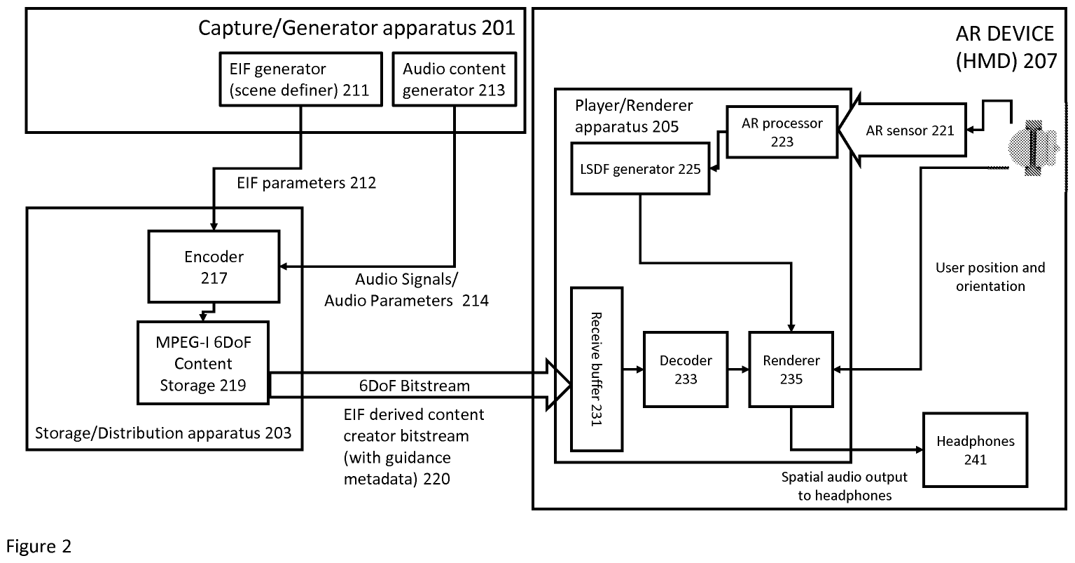

FIG. 2 gives an overview of the end-to-end AR/VR 6 DoF audio system. There are shown in the example three parts of the system, the capture/generator apparatus 201 configured to capture/generate the audio information and associated metadata, the storage/distribution apparatus 203 configured to encode and store/distribute the audio information and associated metadata and the augmented reality (AR) device 207 configured to output a suitable processed audio signal based on the audio information and associated metadata. The AR device 207 in the example shown in FIG. 2 has the 6 DoF audio player 205 which renders retrieves the 6 DoF bitstream from the storage/distribution apparatus 203 and renders it.

In some embodiments as shown in FIG. 2 the capture/generator apparatus 201 comprises an encoder input format (EIF) generator 211. The encoder input format (EIF) generator 211 (or in more general the scene definer) is configured to define the 6 DoF audio scene. In some embodiments the scene may be described by the EIF (encoder input format) or any other suitable 6 DoF scene description format. The EIF also references the audio data comprising the audio scene. The encoder input format (EIF) generator 211 is configured to create EIF (Encoder Input Format) data, which is the content creator scene description. The scene description information contains virtual scene geometry information such as positions of audio elements. Furthermore the scene description information may comprise other associated metadata such as directivity and size and other acoustically relevant elements. For example the associated metadata could comprise positions of virtual walls and their acoustic properties and other acoustically relevant objects such as occluders. An example of acoustic property is acoustic material properties such as (frequency dependent) absorption or reflection coefficients, amount of scattered energy, or transmission properties. In some embodiments, the virtual acoustic environment can be described according to its (frequency dependent) reverberation time or diffuse-to-direct sound ratio. The EIF generator 211 in some embodiments may be more generally known as a virtual scene information generator. The EIF parameters 214 can in some embodiments be provided to a suitable (MPEG-I) encoder 217.

Furthermore in some embodiments the encoder input format (EIF) generator 211 is configured to generate anchor reference information. The anchor reference information may be defined in the EIF to indicate that the position of the specified audio elements are to be obtained from the listener space via the LSDF.

In some embodiments the capture/generator apparatus 201 comprises an audio content generator 213. The audio content generator 213 is configured to generate the audio content corresponding to the audio scene. The audio content generator 213 in some embodiments is configured to generate or otherwise obtain audio signals associated with the virtual scene. For example in some embodiments these audio signals may be obtained or captured using suitable microphones or arrays of microphones, be based on processed captured audio signals or synthesised. In some embodiments the audio content generator 213 is furthermore configured in some embodiments to generate or obtain audio parameters associated with the audio signals such as position within the virtual scene, directivity of the signals. The audio signals and/or parameters 212 can in some embodiments be provided to a suitable (MPEG-I) encoder 217.

In some embodiments the storage/distribution apparatus 203 comprises an encoder 217. The encoder is configured to receive the EIF parameters 212 and the audio signals/audio parameters 214 to generate a suitable bitstream.

The encoder 217 for example can use the EIF parameters 212, the audio signals/audio parameters 214 and the guidance parameters 216 to generate the MPEG-I 6 DoF audio scene content which is stored in a format which can be suitable for streaming over the network. The delivery can be in any suitable format such as MPEG-DASH (Dynamic Adaptive Streaming Over HTTP), HLS (HTTP Live Streaming), etc. The 6 DoF bitstream carries the MPEG-H encoded audio content and MPEG-I 6 DoF bitstream. The content creator bitstream generated by the encoder on the basis of EIF and audio data can be formatted and encapsulated in a manner analogous to MHAS packets (MPEG-H 3D audio stream). The encoded bitstream in some embodiments is passed to a suitable content storage module. For example as shown in FIG. 2 the encoded bitstream is passed to a MPEG-16 DoF content storage 219 module. Although in this example the encoder 217 is located within the storage/distribution apparatus 203 it would be understood that the encoder 217 can be part of the capture/generator apparatus 201 and the encoded bitstream passed to the content storage 219.

In some embodiments the storage/distribution apparatus 203 comprises a content storage module. For example as shown in FIG. 2 the encoded bitstream is passed to a MPEG-I 6 DoF content storage 219 module. In such embodiments the audio signals are transmitted in a separate data stream to the encoded parameters. In some embodiments the audio signals and parameters are stored/transmitted as a single data stream or format or delivered as multiple data streams.

The content storage 219 is configured to store the content (including the EIF derived content creator bitstream) and provide it to the AR device 207.

In some embodiments the capture/generator apparatus 201 and the storage/distribution apparatus 203 are located in the same apparatus.

In some embodiments the AR device 207 which may comprise a head mounted device (HMD) is the playback device for AR consumption of the 6 DoF audio scene.

The AR device 207 in some embodiments comprises at least one AR sensor 221. The at least one AR sensor 221 may comprise multimodal sensors such as visual camera array, depth sensor, LiDAR, etc. The multimodal sensors are used by the AR consumption device to generate information of the listening space. This information can comprise material information, objects of interest, etc. This sensor information can in some embodiments be passed to an AR processor 223.

In some embodiments the AR device 207 comprises a player/renderer apparatus 205. The player/renderer apparatus 205 is configured to receive the bitstream comprising the EIF derived content creator bitstream (with guidance metadata) 220, the AR sensor information and the user position and/or orientation and from this information determine a suitable audio signal output which is able to be passed to a suitable output device, which in FIG. 2 is shown as headphones 241 (which may be incorporated within the AR device 207).

In some embodiments the player/renderer apparatus 205 comprises an AR processor 223. The AR processor 223 is configured to receive the sensor information from the at least one AR sensor 221 and generate suitable AR information which may be passed to the LSDF generator 225. For example, in some embodiments, the AR processor is configured to perform a fusion of sensor information from each of the sensor types.

In some embodiments the player/renderer apparatus 205 comprises a listening space description file (LSDF) generator 225. The listening space description file (LSDF) generator 225 is configured to receive the output of the AR processor 223 and from the information obtained from the AR sensing interface generate the listening space description for AR consumption. The format of the listening space can be in any suitable format. The LSDF creation can use the LSDF format. This description carries the listening space or room information including acoustic properties (e.g., mesh enveloping the listening space including materials for the mesh faces), audio elements or geometry elements of the scene with spatial locations that are dependent on the listening space are referred to as anchors in the listening space description. The anchors may be static or dynamic in the listening space. The LSDF generator is configured to output this listening scene description information to the renderer 235.

In some embodiments the player/renderer apparatus 205 comprises a receive buffer 231 configured to receive the content creator bitstream 220 comprising the EIF information. The buffer 231 is configured to pass the received data and pass the data to a decoder 233.

In some embodiments the player/renderer apparatus 205 comprises a decoder 233 configured to obtain the encoded bitstream from the buffer 231 and output decoded EIF information (with decoded audio data when it is within the same data stream) to the renderer 235.

In some embodiments the player/renderer apparatus 205 comprises a renderer 235. The renderer 235 is configured to receive the decoded EIF information (with decoded audio data when it is within the same data stream), the listening scene description information and listener position and/or orientation information. The listener position and/or orientation information can be obtained from the AR device configured with suitable listener tracking apparatus and sensors which enable providing accurate listening position as well as orientation. The renderer 235 is further configured to generate the output audio signals to be passed to the output device, as shown in FIG. 2 by the spatial audio output to the headphones 241.

The renderer 235 is configured to obtain the content creator bitstream (i.e. MPEG-I 6 DoF bitstream which carries the scene origin and orientation anchors) and LSDF (i.e. the origin and orientation anchors in the actual listening space) and then be configured to implement a correspondence mapping such that the origin and orientation in the content creators are mapped to the origin and orientation within the listening space description information.

The renderer 235 in summary can be considered to receive a description of the listening space as a Listener Space Description Format (LSDF) file. The renderer 235 then renders the scene based on the information from the sources. The EIF may contain references to anchors in the LSDF for the purpose of positioning scene elements relative to the anchors. The anchors in the LSDF may be automatically found points of interest such as doors windows or they may be user defined positions. Thus if the content creator wishes to place content near a window in the listening space, he may refer to “window” anchors in the EIF.

However there can be circumstances where the size (dimensions) of an AR scene that a content creator has created may be larger than the listening space the user is using to consume the content in. This causes at least some parts of the AR content to be placed outside of the user's listening space creating a suboptimal experience. An audio object that is placed outside of the listening space, for example, may not be audible at all to the user if the geometry of the listening space is taken into account in the audio rendering.

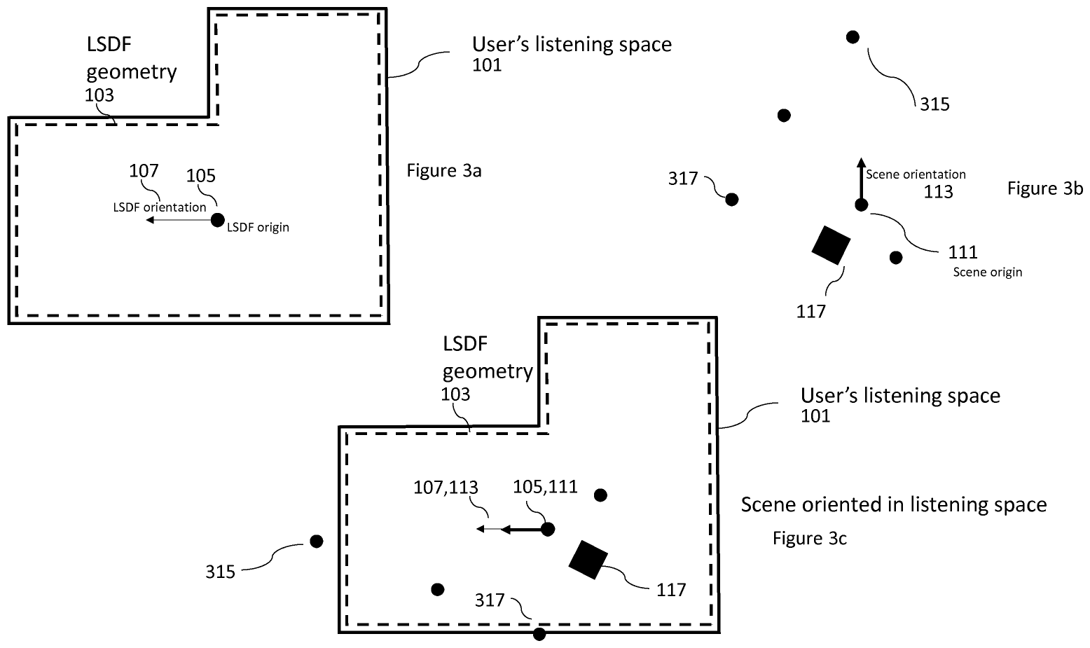

Such an example is shown with respect to FIGS. 3a to 3c. The example shown in FIG. 3a is the same as the example shown in FIG. 1a.

FIG. 3b shows an example virtual scene information which may be described during content creation (or by a suitable capture apparatus or device) and represents the scene as captured (or initially generated) which differs from the example shown in FIG. 1b in that some of the scene sources 315, represented by the circles are located further from the scene origin 111.

FIG. 3c shows an example combination of the scene orientated within the user's (or listener's) space 101 where the scene origin 111 and LSDF origin 105 are aligned and the scene orientation 113 aligned with the LSDF orientation 107. In this example once aligned the scene fits within the user's space. In this example there is shown one scene source 315 which is located outside the listening space 101 and as such may not contribute to the rendered scene and a further scene source 317 which is located at the boundary of the listening space and as such effects such as reflections and reverberances from such a source may be implemented which produces an effect which could undermine the aimed effect of an immersive experience.

The concept as discussed further in the following embodiments is one in which there is provided metadata for performing scaling of the (6 DoF) audio scene by modifying audio element positions (such as sources or objects at the renderer) according to the metadata and scale tags positioned by the listener so as to achieve rendering of the scene according to (jointly) content creator intent and listener preference/room size limitations.

The metadata provided in some embodiments describes scale anchors, which are configured to describe the positions of audio elements relative to scale tags. Scale tags in the following embodiments are physical or virtual tags placed by the user in the listening positions that they may use to scale the scene with. The positions of the scale tags can for example define the corners of the space in which the scene is to be placed in.

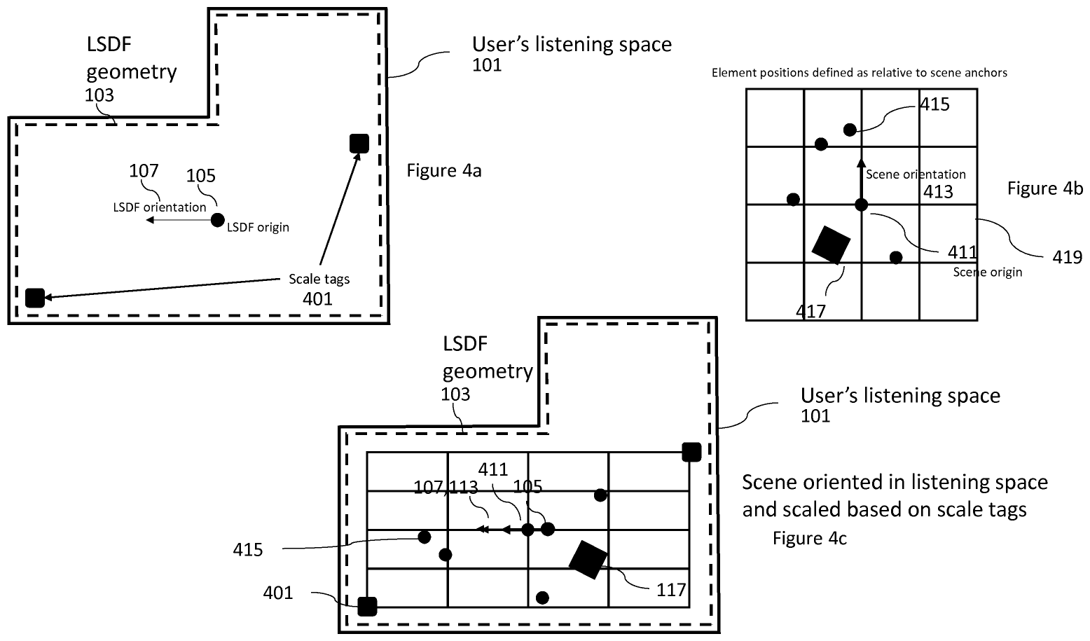

An example of which is shown in FIGS. 4a to 4c. The example shown in FIG. 4a is the same as the example shown in FIGS. 1a and 3a but for the introduction of scale tags 401 within the LSDF geometry 103. For example in FIG. 4a the scale tags 401 are located near the edge of the user's listening space 101 at a first corner in front and to the left of the LSDF origin and orientation and at a location behind and to the right of the LSDF origin and orientation.

FIG. 4b shows an example virtual scene information wherein a scene is defined not only by origin 411 and orientation 413 by scene grid 419 (or anchor grid) from which the scene sources 415, and objects 417 are defined relative to.

FIG. 4c then shows an example combination of the scene orientated and scaled within the user's (or listener's) space 101 where the scene orientation 413 is aligned with the LSDF orientation 107 and the scene grid (or anchor grid) 419 is scaled relative to the scale tags 401. As shown in this example this may generate a situation wherein the listening space (LSDF) origin 105 and the scene origin 411 are not aligned but that the scene (and the sources and objects-which can be more generally defined as audio elements) fits within the user's space. Thus the scene source 415 is located within the listening space 101.

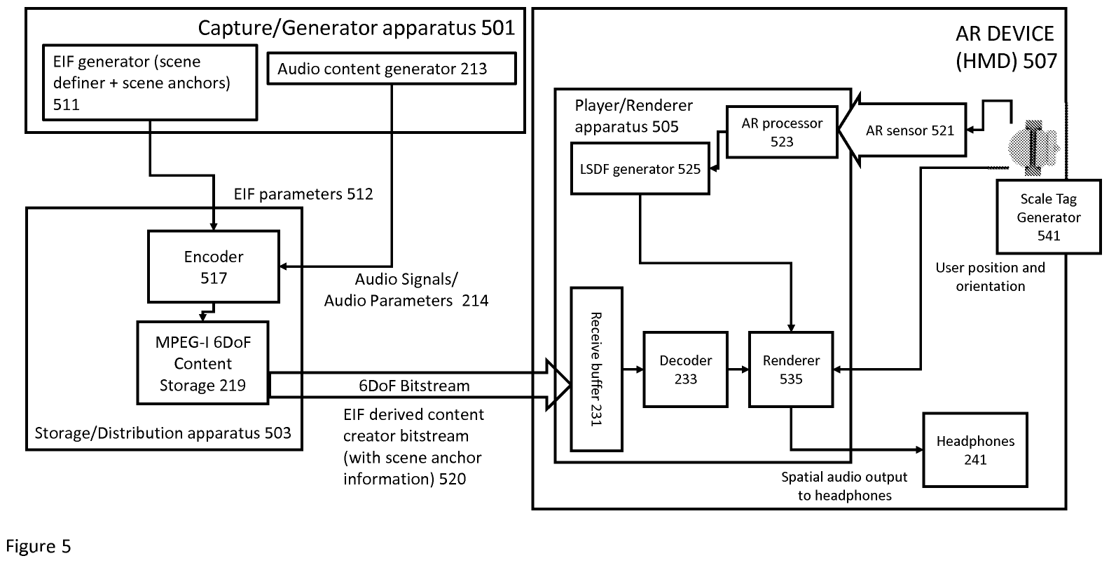

With respect to FIG. 5 is shown a system of apparatus suitable for implementing some embodiments. The system of apparatus is based on the system as shown in FIG. 2. In this example the EIF generator 511 (as part of the capture/generator apparatus 501) replaces the EIF generator 211 and is configured to generate EIF parameters (including scaling anchor information) 512 to the encoder 517, which is configured to encode the EIF parameters 512 and the audio signals/audio parameters 214 and generate EIF derived content creator bitstream (with scene anchor information) 520 which can be passed to the AR device 207.

The capture/generator apparatus 501 in some embodiments comprises an EIF generator 511. The EIF generator 511 is configured to generate the scene description (which can be an encoder input format). The EIF generator 511 in some embodiments is configured to define the scene objects and anchors but can also define which of the objects and anchors are subject to the effect of scaling tags. In other words the generator 511 provides information which indicates to the encoder 217 which audio elements in the scene are to be positioned in the listening space relative to the scaling tags. In the examples described herein an MPEG-I audio context and EIF file generator is described. It would be understood that the scaling information can be indicated to the encoder and thus to the renderer in any suitable format or manner and these examples are just examples which represent how the information can be indicated in the MPEG-I audio context using an EIF file.

In a MPEG-I Audio context, the generator 511 is configured to define the audio scene by creating an Encoder Input Format (EIF) file. To facilitate scene scaling, the EIF definition is augmented with a <ScaleAnchor> element. Any audio elements (<ObjectSource>, <Box>, <Mesh> for example) placed inside the <ScaleAnchor> element indicates that these audio elements are to be positioned with respect to the scaling tags found in the listening space. Furthermore, geometric audio elements, such as <Box>, <Cylinder> or <Mesh> may also be set to be scaled in size relative to the scaling tags. For example

```
<ScaleAnchor id=”scale_anchor” scale_anchor_ref=”scale_tags”>
  <ObjectSource id=”object1”
    position=”0.1 0.75 0.4”
    signal=”signal1”/>
</ScaleAnchor>
```

In some embodiments the Scale anchor relative object source, is placed at a position relative to coordinate space defined by scale tags found in the listening space.

```
<ScaleAnchor id=”scale_anchor” scale_tag_ref=”scale_tags”
tag1_default_position=”−2.0 0.0 −2.0”
tag2_default_position=”2.0 0.0 2.0”>
  <Box id=”box”
    scalable_size=”true”
    position=”0.1 0.75 0.4”
    size=”0.2 0.2 0.2”
    orientation=″0 0 0”/>
</ScaleAnchor>
```

A scale anchor relative box can indicate to the renderer that the box is to be placed at position relative to coordinate space defined by scale tags found in the listening space. In some embodiments when the scalable_size flag is set to “true”, the size of the box is also scaled with respect to the scale tags. Default tag positions are provided in the case of no scale tags found in the listening space.

The capture/generator apparatus 501 in some embodiments comprises an audio content generator 213 which is configured to generate an audio bitstream and associated metadata and pass this to the encoder 517.

The encoder 517 (as part of the storage/distribution apparatus 503) in some embodiments is configured to receive the EIF-file and creates a MPEG-I 6 DoF audio bitstream describing the scene. The bitstream can be formatted and encapsulated in some embodiments in a manner analogous to MHAS packets (MPEG-H 3D audio stream), in a manner as described in ISO/IEC 23008-3:2018 High efficiency coding and media delivery in heterogeneous environments—Part 3: 3D audio.

The encoder 517 can for example be configured to generate metadata structures such as shown below to describe the scaling anchor relative audio elements in the bitstream.

The ScaleAnchorStruct( ) structure for example can be used to indicate which elements are to be placed relative to the scaling tags in the listening space. In some embodiments there may be multiple ScaleAnchorStructs in the ContentCreatorSceneDescriptionStruct, which describes the scene. It has an index (id) and a reference string to match the scale tag ids. Furthermore the structure can be configured such that it comprises AudioElements and GeometryElements, which are to be placed in the scene relative to the scaling tag matching the scale_tag_ref.

| aligned(8) ContentCreatorSceneDescriptionStruct( ){ | |
|---|---|
| Anchors( ); | |
| ScaleAnchors( ); | |
| VirtualSceneDescription( ); | |
| } | |
| aligned(8) ScaleAnchorsStruct ( ){ | |
| unsigned int(16) num_scale_anchors; | |
| for(i=0;i<num_scale_anchors;i++){ | |
| ScaleAnchor( ); | |
| } | |
| } | |
| aligned(8) ScaleAnchorStruct( ){ | |
| unsigned int(16) index; | // anchor index |
| string scale_tag_ref; | // corresponding tag identifier |
| | // in the listening space |
| | //description |
| AudioElements( ); | // audio elements associated |
| | // with this scale anchor |
| GeometryElements( ); | // scene geometry elements |
| | // associated with this scale anchor |

}

The GeometryElementsStruct in some embodiments is configured to comprise and define geometric audio elements that are to be placed (and scaled) relative to the scale tags. In the example below, the structure for a Box element is shown, (and a similar approach may be used for other geometric audio elements, such as cylinders or meshes). In some embodiments parameters such as Position( ) and Size( ) are used to indicate a relative position and possibly relative size of the Box (and similarly for other geometric audio elements).

```
aligned(8) GeometryElementsStruct( )
  unsigned int(16) num_boxes;
  for(i=0;i<num_boxes;i++){
    Box( );
  }
  ...
  }
aligned(8) BoxStruct( ) {
```

| | |
|---|---|
| unsigned int(16) index; | // box index |
| Position( ); | // position of box |
| Size( ); | // size of box |

...
}
aligned(8) Position( ) {

| | |
|---|---|
| signed int(32) pos_x; | // positions relative to the |
| | // scale tags |

```
  signed int(32) pos_y;
  signed int(32) pos_z;
```

| | |
|---|---|
| signed int(32) orient_yaw; | // orientations relative to |
| | // the scale tags |

```
  signed int(32) orient_pitch;
  signed int(32) orient_roll;
}
aligned(8) Size( ) {
  signed int(32) size_x;
  signed int(32) size_y;
  signed int(32) size_z;
```

| | |
|---|---|
| unsigned int(1) scalable; | // if 1 sizes are relative to |
| | // scale tags |
| | // if 0 sizes are absolute |

bit(7) reserved = 0;
}

In some embodiments the encoder is configured to generate AudioElementsStruct structures which indicate audio elements that are to be placed relative to the scale tags. In the example shown below, the structure for a Objectsource element is shown, however a similar approach may be used for other audio elements, such as Channel or HOA sources. Position( ) parameters in some embodiments can be employed to indicate the relative positions and possibly relative size of the ObjectSource.

| aligned(8) AudioElementsStruct( ) | |
|---|---|
| unsigned int(16) num_object_sources; | |
| for(i=0;i<num_object_sources;i++){ | |
| ObjectSource( ); | |
| } | |
| ... | |
| } | |
| aligned(8) ObjectSourceStruct( ) { | |
| unsigned int(16) index; | // box index |
| Position( ); | // position of object source |

...
}

The AR device 507 is the playback device for AR consumption of the 6 DoF audio scene. The AR device 507 is similar to the AR device 207 as shown in FIG. 2 with the following components.

The AR device 507 in some embodiments comprises a scale tag generator 541. The scale tag generator 541 can for example be configured to generate virtual tags that may be placed in positions inside the listening space by the user by operating the HMD. This may be done in a configuration step of the device or live during rendering of the content (from a settings menu, for example). For example the user operating the AR device 507 can select using a suitable user interface and based on an image captured by the AR sensor 521 a suitable tag target or location (for example a table, a window, or mark on the wall of the room) which can be used to ‘mark’ a position for the scale tag.

In some embodiments the scale tag generator 541 is not present and the scale tags are physical tags with means of being detected and located by the AR device 507. For example in some embodiments the scale tags may comprise physical tags equipped with suitable radio-beacon or visual identifiers able to be detected by the AR device 507 and the AR sensor 521. In some embodiments Radio-based or visual based positioning of the tags may be employed by the AR device. The scale tag information can in some embodiments be passed to the AR processor 523 and/or LSDF generator 525

The AR device 507 in some embodiments comprises at least one AR sensor 521. The at least one AR sensor 521 may comprise multimodal sensors such as visual camera array, depth sensor, LiDAR, etc. The multimodal sensors are used by the AR consumption device to generate information of the listening space. This information can comprise material information, objects of interest, etc. This sensor information can in some embodiments be passed to an AR processor 523.

In some embodiments the player/renderer apparatus 505 comprises an AR processor 523. The AR processor 523 is configured to receive the sensor information from the at least one AR sensor 521 and generate suitable AR information which may be passed to the LSDF generator 525. For example, in some embodiments, the AR processor is configured to perform a fusion of sensor information from each of the sensor types. Additionally the AR processor 523 can be configured to track the positions of the scale tags positioned by the user.

In some embodiments the player/renderer apparatus 505 comprises a listening space description file (LSDF) generator 525. The listening space description file (LSDF) generator 525 is configured to receive the output of the AR processor 523 and from the information obtained from the AR sensor 521 (and the scale tag generator 541) generate the listening space description for AR consumption. The format of the listening space can be in any suitable format. The LSDF creation can use the LSDF format. This description carries the listening space or room information including acoustic properties (e.g., mesh enveloping the listening space including materials for the mesh faces), audio elements or geometry elements of the scene with spatial locations that are dependent on the listening space are referred to as anchors in the listening space description. The anchors may be static or dynamic in the listening space. The LSDF generator is configured to output this listening scene description information to the renderer 535.

The generator 525 in some embodiments is configured to add or insert the positions of the scale tags into the LSDF file (or generically the listener space description) that is passed to the renderer.

For example a <ScaleTag> element can be added to the LSDF, the <ScaleTag> can in some embodiments have the following format:

<ScaleTag id=“scale_tag1” position=“1. 0 1.2 −1.6”/>
<ScaleTag id=“scale_tag2” position=“−1. 0 1.2 1.6”/>

where the scale tag as an identifier ScaleTag id and position field.

The generator 525 can then output the listener space description which comprises the scale tag information, and which in this example is in a LSDF format, to the renderer 535.

The player/renderer apparatus 505 in some embodiments comprises a renderer 535. The renderer 525 is configured to obtain the content creator bitstream (i.e. MPEG-I 6 DoF bitstream which carries references to anchors in LSDF) and LSDF (i.e. anchor position in the actual listening space). The correspondence mapping is performed in the renderer.

Thus for example the renderer 525 is configured to perform the following operations:

Obtain listening space information (LSDF): The renderer 525 is configured to obtain the listener space description (for example the LSDF) which includes information about the listening space. More specifically, the scale tag positions (xₜ₁, yₜ₁) and (xₜ₂, yₜ₂) and listening space origin and orientation (d) are obtained.

Calculate tag origin: The renderer 535 is then further configured to determine or calculate a “tag origin” (xₜₒ, yₜₒ) which is the origin used for calculating tag relative positions. The tag origin can in some embodiments be obtained using the following expression:

$$( {x}_{to} , {y}_{to} ) = ( ( {x}_{t 1} - {x}_{t 2} ) / 2 , ( {y}_{t 1} - {y}_{t 2} ) / 2 )$$

Calculate scaling multipliers: The renderer 535 can furthermore be configured to determine or calculate scaling multipliers mx and my for the purpose of positioning tag relative audio elements. In some embodiments the scaling multipliers can be determined using the following expressions:

$${m}_{y} = length ( {c}_{1} - {c}_{4} ) / 2$$

$${m}_{x} = length ( {c}_{1} - {c}_{3} ) / 2$$

where c1, c2, c3 and c4 are corner positions of rectangle defined by scale tags are listening space orientation (d):

c1 is the tag 1 position relative to the tag origin
c2 is the tag 2 position relative to the tag origin
c3 is obtained by mirroring c1 over the listening space orientation (d)
c4 is obtained from the formula c4=−c3

Obtain audio element (relative) position: The renderer 535 in some embodiments be configured to obtain the tag relative position (xᵣₒ₁, yᵣₒ₁) for an audio elements from the decoded scene description.

Calculate audio element scaled position: The position of the audio element in the scene (xₒ₁, yₒ₁) can then be determined by the renderer 535. For example in some embodiments the following expression can be use to obtain the position:

$$( {x}_{o 1} , {y}_{o 1} ) = ( {x}_{to} , {y}_{to} ) + ( {x}_{ro 1} * {m}_{x} , {y}_{ro 1} * {m}_{y} )$$

Note that in the above example there is no consideration of the z-axis (up-down). For most scenes, it is sufficient to apply the scaling only for the x and y coordinates. Thus, in some embodiments, the position coordinate values in the EIF are relative only for the x and y coordinates and absolute for the z coordinate. However it would be understood that a similar scaling can be performed in 3 dimensions.

The renderer 535 can furthermore be configured to receive user position and orientation information and based on this and the determined audio elements generate a suitable spatial audio output, for example as shown in FIG. 5 the headphones.

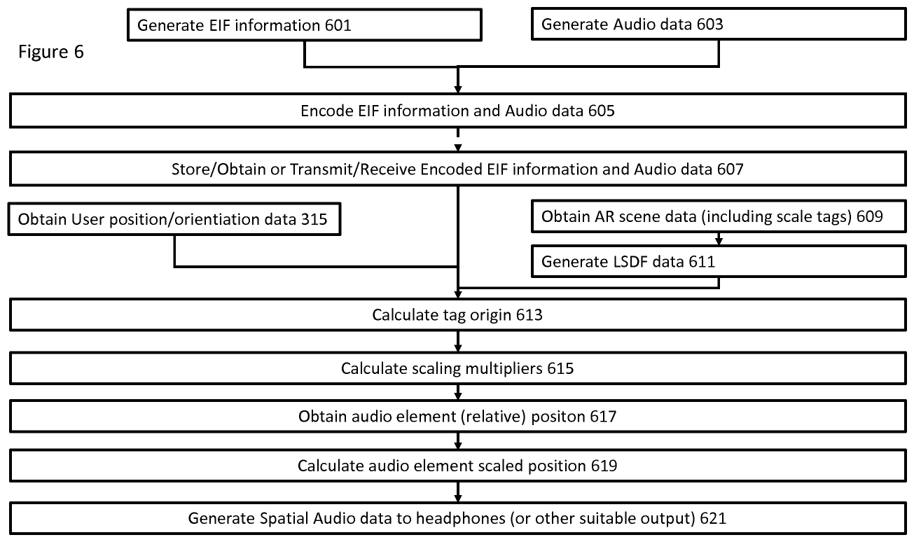

With respect to FIG. 6 is shown an example operation of the system shown in FIG. 5.

The EIF information is generated (or obtained) comprising the element anchor information as shown in FIG. 6 by step 601.

The audio data is furthermore obtained (or generated) as shown in FIG. 6 by step 603.

The EIF information, and audio data is then encoded as shown in FIG. 6 by step 605.

The encoded data is then store/obtained or transmitted/received as shown in FIG. 6 by step 607.

Additionally the AR scene data (including scale tag data) is obtained as shown in FIG. 6 by step 609.

From the sensed AR scene data a listening space description (file) information is generated as shown in FIG. 6 by step 611.

Furthermore the listener/user position and/or orientation data can be obtained as shown in FIG. 6 by step 613.

The tag origin is then calculated as shown in FIG. 6 by step 613.

The scaling multipliers can then be calculated as shown in FIG. 6 by step 615.

The audio element (relative) position can then be obtained as shown in FIG. 6 by step 617.

Then the scaled position of the audio element is calculated as shown in FIG. 6 by step 619.

Having determined the scaled position of the audio elements then the spatial audio data is generated and output to headphones or any suitable output as shown in FIG. 6 by step 621.

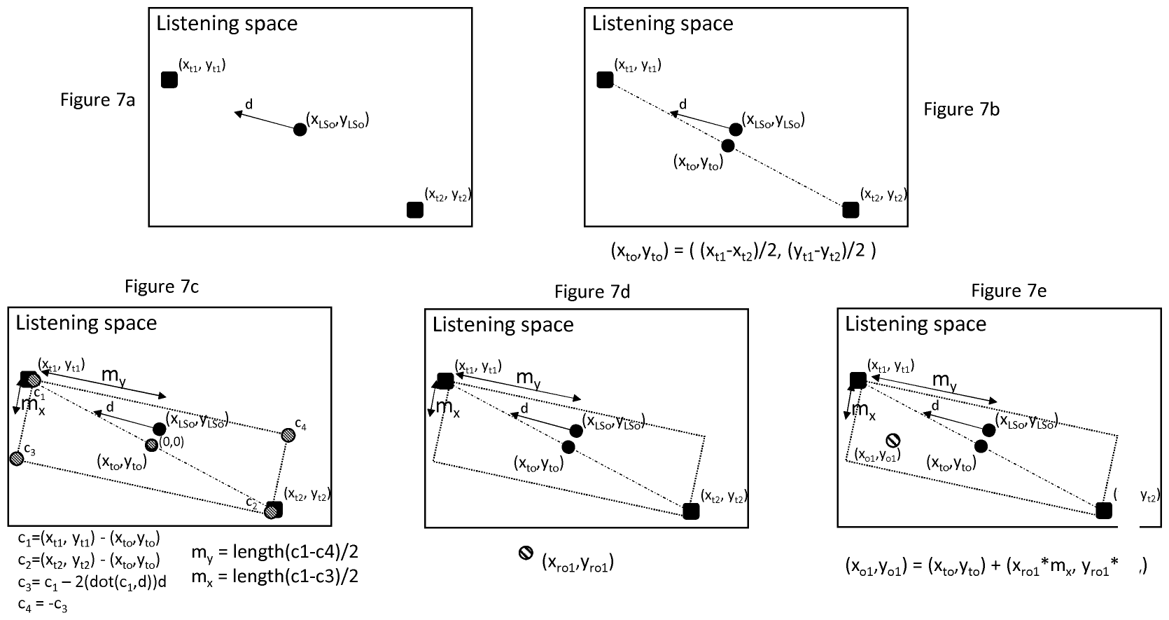

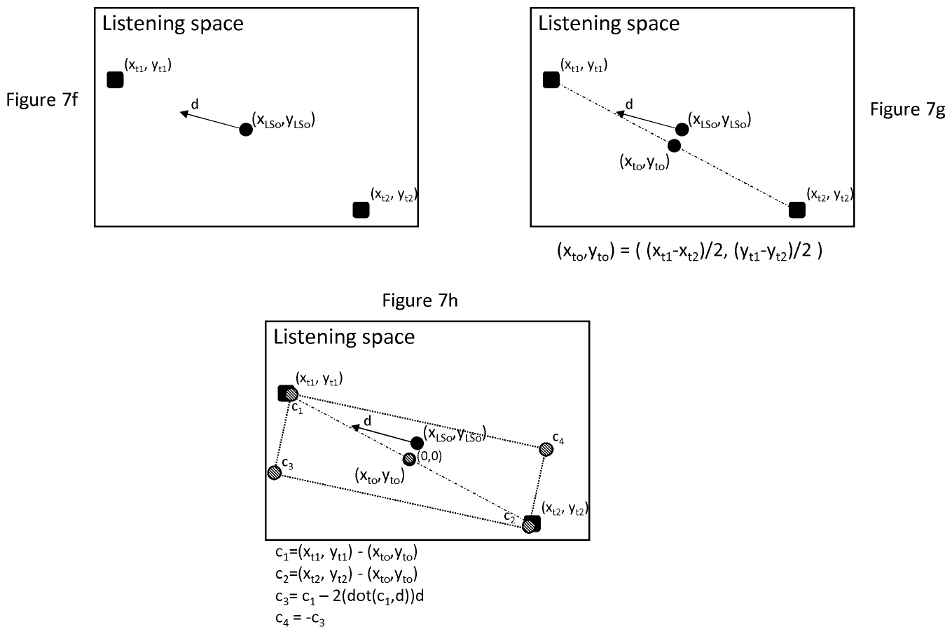

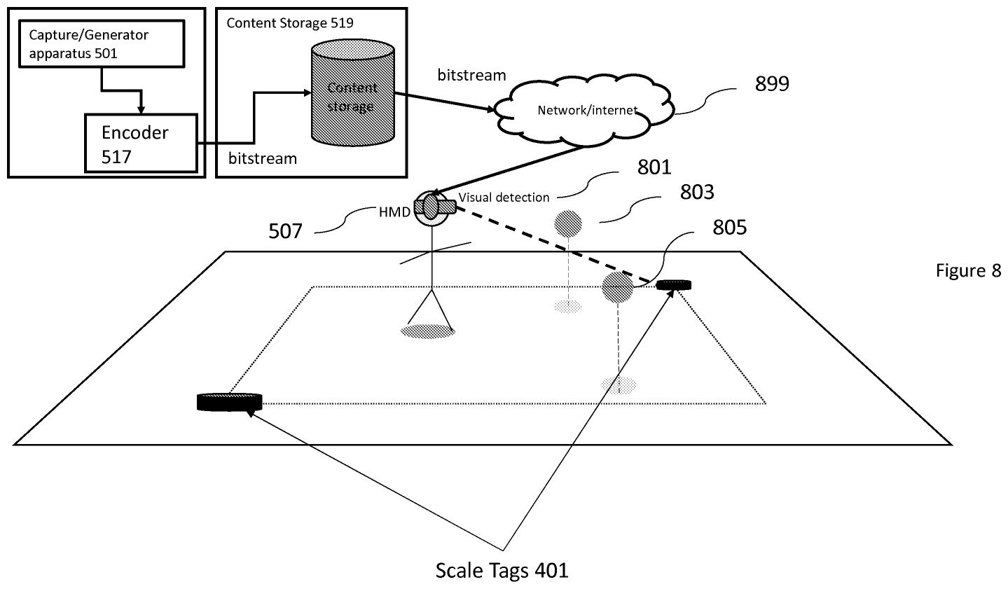

FIGS. 7a to 7h show an example of the combining the listening space and audio scene information.

FIG. 7a shows for example the listening space origin (x_{LSo}, y_{LSo}) and orientation d (unit vector) and furthermore the scale tags positions (xₜ₁, yₜ₁) and (xₜ₂, yₜ₂) within the listening space.

FIG. 7b shows the determination of a tag origin (xₜₒ, yₜₒ) located between the two scale tag positions=((xₜ₁−xₜ₂)/2, (yₜ₁−yₜ₂)/2).

FIG. 7c shows the determination of the scaling multipliers m_{y} and mₓ. Scaling multipliers are obtained by determining the corner positions c1, c2, c3 and c4 of a rectangle that has two corners at tag positions and whose sides are perpendicular or parallel to the listening space orientation. The positions c1, c2, c3, c4 are defined relative to the tag origin and are obtained as follows.
c1 is the tag 1 position relative to the tag origin
c2 is the tag 2 position relative to the tag origin
c3 is obtained by mirroring c1 over the listening space orientation
c4 is obtained from the formula c4=−c3

The scaling multipliers are then obtained from m_{y}=length (C₁−C₄)/2 and mx=length (C₁−C₃)/2. FIG. 7d shows the introduction of the audio element at the position (xᵣₒ₁, yᵣₒ₁).

Then FIG. 7e shows the mapping of the audio element into the listening space using the tag origin and scaling multipliers such that the audio element position is determined as (xₒ₁, yₒ₁)=(xₜₒ, yₜₒ)+(xᵣₒ₁*mₓ, yᵣₒ₁*m_{y}).

In some embodiments, the listening area defined by the scale tags is used to indicate a scene boundary. Any audio content that has been indicated in the metadata to react to the listening area defined by the scale tags is rendered such that if it falls outside of the scene boundary it is not rendered and if it stays inside the scene boundary, it is rendered. In such embodiments a user may adjust the scene boundary so that any real-life objects are not blocked by AR content. For example, the user may wish to adjust the scene boundary such that a television in his listening space is outside of the scene boundary making sure that no AR content is placed near the TV. Alternatively, the content which stays outside of the scene boundary is rendered, but modified to not be interactable (not moveable by the listener, for example). The scene boundary may be obtained by determining corner points c1, c2, c3 and c4 of a rectangle based on the listening space direction and the scale tags as shown in FIGS. 7f, 7g and 7h.

In some embodiments rendering of 3 DoF content can be implemented where the user translation is not taken into account by the renderer during rendering. In these embodiments, any distance information in the content is modified based on the size of the area defined by the scale tags. The larger the area, the larger distances are used.

In some embodiments with limited capability devices, there may be no information of the listening area being determined or being obtained by the renderer. In such embodiments the AR device is configured to only track the position relative to an origin. In these embodiments the scaling anchors/scale tags can be employed as there is no other way of scaling the scene (e.g. room dimensions cannot be used).

Furthermore in some embodiments AR device is configured to be tracked from the outside using tracking beacons. The same beacons may be used to track the position of the Scale Tags. Tracking information and relative positions of the Scale Tags can be sent to the AR device which in turn then renders and scales content accordingly.

In some embodiments the scale tag can also be employed in a VR system. In such embodiments, the tags are employed to quickly adjust the size of the play area (and scale content) for VR. For example currently, in HTC Vive systems the play area is defined in a calibration step. However by employing the above embodiments the play area can be adjusted during content consumption. As in the outside tracking embodiments described above, the same tracking system that is used to track the VR user is used for tracking the Scale Tags. One real-world example could be a user consuming content in the living room using VR and during the consumption, other family members need part of the space and can move the tags to resize the content area-even during the content consumption.

With respect to FIG. 8 is shown an example system wherein a network/internet 899 is located between the content storage 519 and AR device/HMD 507 and the AR device 507 employs visual detection of the scale tags 401 which can then be used to assist in the locating of the audio elements 803/805.

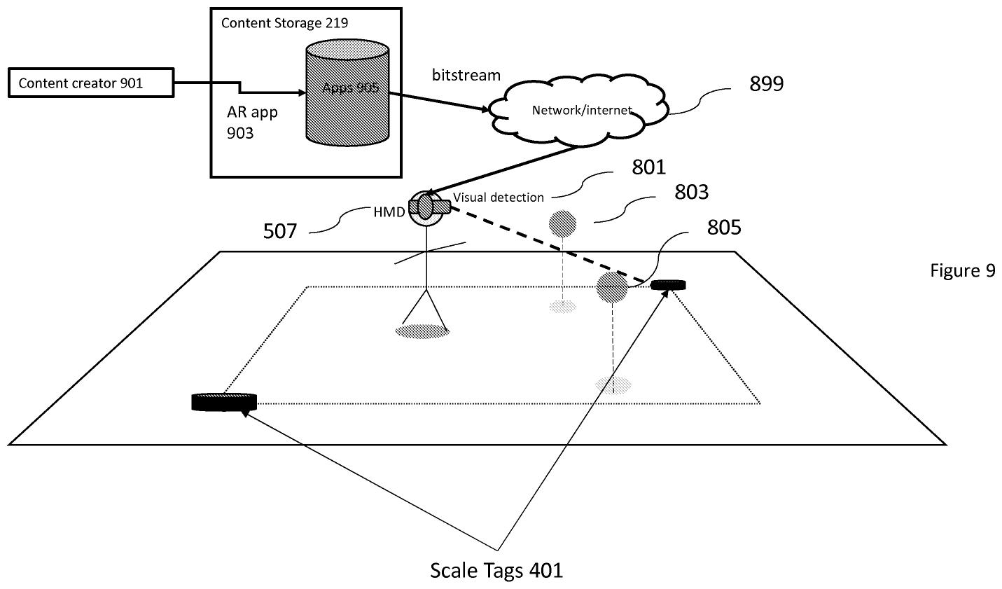

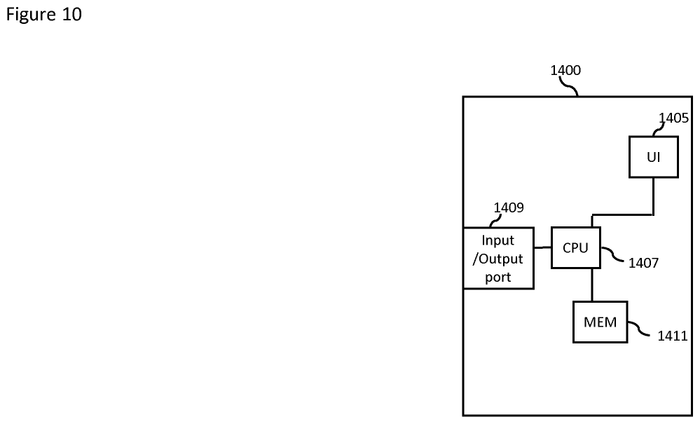

Furthermore is shown in FIG. 9 an AR application implementation of the system according to some embodiments. In such a case, the app/content creator 901 is configured to indicate how the scene will be scaled along with the scale tags. Thus, no encoder component is required in this embodiment. The user downloads from an app storage 905 or content storage 219 and installs the app 903 on his HMD 507, which then (when app is run) renders audio according to the provided description. In some embodiments, the app may also comprise a mechanism for positioning virtual scale tags 401 in the room based on which the content 901/903 is scaled. These virtual tags 401 may be placed in the listening space using hand gestures detected by the HMD. Once placed in the listening space, the virtual tags are used for scaling the scene.

With respect to FIG. 7 an example electronic device which may represent any of the apparatus shown above. The device may be any suitable electronics device or apparatus. For example in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus for generating information to assist rendering an audio scene, the apparatus comprising:
at least one processor; and
at least one memory storing instructions that, when executed with the at least one processor, cause the apparatus at least to:
obtain at least one audio signal;
obtain at least one scene parameter associated with the at least one audio signal, the at least one scene parameter being configured to define a position within the audio scene, wherein the audio scene is defined [by]] with the at least one audio signal and the at least one scene parameter;
obtain at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being at least one of a virtual or physical space within which the audio scene is rendered, wherein the mapped position is at least one of scaled to fit within the listening space or the mapped position at least in part modifies the listening space; and
generate a bitstream comprising the at least one audio signal, the at least one scene parameter, and at least one anchor parameter.

2. The apparatus as claimed in claim 1, wherein the instructions, when executed with the at least one processor, further cause the apparatus to obtain a scene origin parameter wherein the position within the audio scene is defined relative to the scene origin parameter, and wherein the bitstream further comprises the scene origin parameter.

3. The apparatus as claimed in claim 1, wherein the at least one anchor parameter defines a geometric shape at least partially defining a boundary of the audio scene wherein the position is within the boundary of the audio scene, and the mapped position maps the boundary of the audio scene within the listening space.

4. The apparatus as claimed in claim 1, wherein the instructions, when executed with the at least one process, cause the apparatus to at least one of:
store the generated bitstream; or
transmit the generated bitstream.

5. An apparatus for rendering an audio scene within a listening space, the apparatus comprising:
at least one processor; and
at least one memory storing instructions that, when executed with the at least one processor, cause the apparatus at least to:
obtain a bitstream, the bitstream comprising:
at least one audio signal;
at least one scene parameter associated with the at least one audio signal, the at least one scene parameter being configured to define a position within the audio scene, wherein the audio scene is defined with the at least one audio signal and the at least one scene parameter; and
at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene;
obtain at least one listening space anchor, the at least one listening space anchor configured to at least partially define a listening space geometry;
obtain a listener position relative to the listening space;
map the position within the audio scene to a listening space position within the listening space wherein the instructions, when executed with the at least one processor, cause the apparatus to map the position within the listening space based on the position within the audio scene, the at least one anchor parameter, and the at least one listening space anchor such that the audio scene is at least one of scaled to fit within the listening space or the mapped position at least in part modifies the listening space; and
render at least one spatial audio signal based on the listener position within the listening space, the at least one audio signal, and the listening space position within the listening space.

6. The apparatus as claimed in claim 5, wherein the at least one anchor parameter at least partially defines a geometric shape defining a boundary of the audio scene.

7. The apparatus as claimed in claim 6, wherein the bitstream further comprises a scene origin, and wherein the instructions, when executed with the at least one processor, cause the apparatus to render the at least one spatial audio signal further based on the listening position within the listening space and the scene origin with respect to the geometric shape defining the boundary of the audio scene.

8. The apparatus as claimed in claim 5, wherein the instructions, when executed with the at least one processor, cause the apparatus to obtain at least one listening space parameter, the at least one listening space parameter configured to define a listening space geometry in which the instructions cause the apparatus to:
measure the listening space geometry;
receive the listening space geometry from at least one user input; and
determine the listening space geometry from signals received from tracking beacons within the listening space.

9. The apparatus as claimed in claim 5, wherein the instructions, when executed with the at least one processor, cause the apparatus to:
generate scaling multipliers based on the at least one anchor parameter and the associated at least one listening space anchor; and
apply the scaling multipliers to the position within the audio scene to determine the position within the listening space.

10. The apparatus as claimed in claim 5, wherein the instructions, when executed with the at least one processor, cause the apparatus to modify at least one of:
the listening space such that the listening space is cropped;
the listening space such that the listening space is cut;
the listening space such that the listening space is limited; or
the listening space such that a listening space area is limited and interaction with any sound sources outside the listening space area is not possible.

11. A method for an apparatus for generating information to assist rendering an audio scene, the method comprising:
obtaining at least one audio signal;
obtaining at least one scene parameter associated with the at least one audio signal, the at least one scene parameter being configured to define a position within the audio scene, wherein the audio scene is defined with the at least one audio signal and the at least one scene parameter;
obtaining at least one anchor parameter associated with the at least one audio signal, wherein the at least one anchor parameter is associated with at least one listening space anchor located within a listening space during rendering and the at least one anchor parameter is configured to assist in mapping the position within the listening space, the listening space being at least one of a virtual or physical space within which the audio scene is rendered, wherein the mapped position is at least one of scaled to fit within the listening space or the mapped position at least in part modifies the listening space; and
generating a bitstream comprising the at least one audio signal, the at least one scene parameter and at least one anchor parameter.

12. The method as claimed in claim 11, wherein the method further comprises obtaining a scene origin parameter wherein the position within the audio scene is defined relative to the scene origin parameter, and wherein the bitstream further comprises the scene origin parameter.

13. The method as claimed in claim 11, wherein the at least one anchor parameter defines a geometric shape at least partially defining a boundary of the audio scene wherein the position is within the boundary of the audio scene, and the mapped position maps the boundary of the audio scene within the listening space.

14. The method as claimed in claim 11, wherein the generated bitstream is at least one of: stored; or transmitted.

15. A method for an apparatus for rendering an audio scene within a listening space, the method comprising:
obtaining a bitstream, the bitstream comprising:
at least one audio signal;
at least one scene parameter associated with the at least one audio signal, the at least one scene parameter being configured to define a position within the audio scene, wherein the audio scene is defined [[by] with the at least one audio signal and the at least one scene parameter; and
at least one anchor parameter associated with the at least one audio signal, wherein the at least one anchor parameter is associated with at least one listening space anchor located within a listening space and the at least one anchor parameter is configured to assist in mapping the position within the audio scene when rendering the audio scene;
obtaining at least one listening space anchor, the at least one listening space anchor configured to at least partially define a listening space geometry;
obtaining a listener position relative to the listening space;
mapping the position within the audio scene to a listening space position within the listening space wherein mapping the position within the audio scene to the listening space position comprises mapping the position within the listening space based on the position within the audio scene, the at least one anchor parameter, and the at least one listening space anchor such that the audio scene is at least one of scaled to fit within the listening space or the mapped position at least in part modifies the listening space; and
rendering at least one spatial audio signal based on the listener position within the listening space, the at least one audio signal, and the listening space position within the listening space.

16. The method as claimed in claim 15, wherein the at least one anchor parameter at least partially defines a geometric shape defining a boundary of the audio scene.

17. The method as claimed in claim 16, wherein the bitstream further comprises a scene origin, and wherein rendering at least one spatial audio signal based on the listener position within the listening space, the at least one audio signal, and the listening space position within the listening space comprises rendering the at least one spatial audio signal further based on the listening position within the listening space and the scene origin with respect to the geometric shape defining the boundary of the audio scene.

18. The method as claimed in claim 15, further comprising obtaining at least one listening space parameter, the at least one listening space parameter configured to define a listening space geometry, comprises:
measuring the listening space geometry;
receiving the listening space geometry from at least one user input; and
determining the listening space geometry from signals received from tracking beacons within the listening space.

19. The method as claimed in claim 15, wherein mapping the position within the audio scene to the listening space position comprises:
generating scaling multipliers based on the at least one anchor parameter and the associated at least one listening space anchor; and
applying the scaling multipliers to the position within the audio scene to determine the position within the listening space.

20. The method as claimed in claim 15, wherein mapping the position within the audio scene to the listening space position comprises modifying at least one of:
the listening space such that the listening space is cropped;
the listening space such that the listening space is cut;
the listening space such that the listening space is limited; or
the listening space such that a listening space area is limited and interaction with any sound sources outside the listening space area is not possible.

21-22. (canceled)
